(19) United States
(12) Patent Application Publication
(10) Pub. No.: US 2013/0254307 A1
(43) Pub. Date: Sep. 26, 2013

(54) REMOTE INITIATED FRAGRANCE DELIVERY SYSTEM AND FRAGRANCE-ENHANCED COMMUNICATION METHOD

(71) Applicants: George S. Ferzli, Staten Island, NY (US); Christopher George Ferzli, Staten Island, NY (US)

(72) Inventors: George S. Ferzli, Staten Island, NY (US); Christopher George Ferzli, Staten Island, NY (US)

(21) Appl. No.: 13/655,465

(22) Filed: Oct. 19, 2012

Related U.S. Application Data
(60) Provisional application No. 61/549,250, filed on Oct. 20, 2011.

(51) Int. Cl. H04L 12/58; A63F 9/24

(52) U.S. Cl. CPC H04L 51/04; A63F 9/24
USPC 709/206; 463/30

(57) ABSTRACT

A fragrance delivery system includes a fragrance release module electronically coupleable with a suitable computing device so as to provide an electronic interface for remotely actuating the fragrance release module, to bring about a release of fragrance in response to a received command from a remote source. The fragrance release module is acquired by a recipient him or herself, or presented to the recipient by a party desirous of sending a future correspondence to the recipient. Based upon suitable protocols, the fragrance release module is selectively actuated in response to a particular communication or command received by the recipient from the presenting party or by a command generated based on the outcome of a preestablished criteria, such as a positive or negative gaming result.

### CROSS REFERENCE TO RELATED APPLICATIONS

This application claims the benefit of U.S. Provisional Application No. 61/549,250 filed Oct. 20, 2011 entitled REMOTE INITIATED FRAGRANCE DELIVERY SYSTEM AND METHOD.

### BACKGROUND OF THE INVENTION

The present invention relates to a fragrance delivery system and a method of sending and delivering a fragrance-enhanced electronic communication. More particularly, the invention relates to a fragrance delivery system and method which allows remotely actuated release of a stored fragrance in response to reception of an externally transmitted initiating command for enhanced sensory appeal of the recipient.

The human sense of smell has long been thought to have a direct affect on mood. In addition to the sensation of the odor, a particular scent is mainly associated with experiences and emotions. This is believed to be due to the fact that the olfactory receptors responsible for the sensation of smell are connected to the limbic system, including, for example, the hypothalamus, hippocampus, and amygdala portions of the brain, that controls emotions. Of the five human senses, the sense of smell is unique, in that aromas initially trigger an emotional response even before cognitive recognition of the scent by the individual.

It is for this reason that aromas have often been used to elicit a desired mood response though the use of, for example, pheromones, perfumes, colognes, aromatherapy, etc.

Romantically involved individuals have expressed their affection for one another for centuries in the form of love letters. The practice of sending love letters written on scented stationary was once common practice, and added an additional dimension to the mere printed word, albeit perhaps poetic.

With the advent of computers, corresponding by emails or other electronic means has, in large part, replaced the practice of sending paper communications, and in the romantic realm, has had the concomitant effect of quashing passionate overtures. In an attempt to compensate for this affectional deficiency associated with email correspondence, e-cards have been suggested which allow an individual to send an animated greeting card with a selected message to a recipient, which upon opening, greets the party opening the email attachment with an animated, generally multi-media format message of humor or sentimentality consisting of visual and audio content.

Notwithstanding these attempts at adding a human dimension to the often impersonal nature of emails, phone texts and all other electronic messaging, no attempts have been made to restore the art of sending a scented communication to a loved one using computer based modality.

Moreover, the profound effect of particular scents to elicit emotional response has not heretofore been utilized in the context of electronic communication between a sender and a willing recipient, in the romantic context or otherwise.

### SUMMARY OF THE INVENTION

It is an object of the invention to provide a method and system for carrying out the method which provides for the selective emission of at least one selected fragrance, implemented in response to a receipt of an externally generated command initiated by a user of a suitable computing and/or communication device, such as a laptop, netbook or hand-held communication device with processing capabilities (e.g. smartphone), etc.

This and other objects of the invention are achieved by the provision of a fragrance delivery system which includes a fragrance release module electronically coupleable with a suitable computing device so as to provide an electronic interface for remotely actuating the fragrance release module, to bring about a release of fragrance in response to a received command from a remote source. The multimedia aspects of providing a scent in combination with other stimuli is thought to greatly enhance the emotional impact of a communication.

Broadly stated, in accordance with the invention, a fragrance release module capable of releasing one or more desired fragrances when actuated in response to a received command is acquired by a recipient him or herself, or presented to the recipient by a party desirous of sending a future correspondence to the recipient. Based upon suitable protocols, the fragrance release module is selectively actuated in response to a particular communication or command received by the recipient from the presenting party or by a command generated based on the outcome of a preestablished criteria, such as a positive or negative gaming result.

In accordance with an embodiment of the invention, a suitably configured fragrance release module is given by a presenting party (referred to herein as “party” or “presenting party”) to a willing recipient (referred to herein a “recipient”) with whom the party intends to communicate in the future. The module can be given alone or in conjunction with a gift or a greeting card, etc.

After taking possession of the fragrance release module, the recipient is instructed to establish an electronic connection between the fragrance release module and a suitable computing device capable of receiving an electronically transmitted communication from a remote source. Upon receipt of a subsequent electronic communication send by the party, or a specialized command contained within the communication, the fragrance release module is selectively actuated based upon predetermined criteria, and at least one desired fragrance contained therein is released. When coupled with one or more sensory media types directed to the various natural senses (e.g., sight, hearing, etc.) comprising the communication from the party, the experience of the recipient is enhanced by the multimedia effect. Optionally, in addition to reception of a command effective for initiating fragrance release by the fragrance release module, the electronic communication from the party will advantageously further include at least one form of other media, such as, for example, a written letter, video, picture, music file.

In accordance with another embodiment, which is not necessarily directed to personal human interaction in which the presenting party may have romantic interest in the recipient, the invention is directed to application in a less intimate setting, such as when used in various social venues, such as restaurants, theaters, etc., in which the presenting party is a business establishment, rather than a person, and the recipient is a patron thereof.

According to an embodiment of a method of implementing the invention, once the fragrance release module is received, the recipient establishes an electronic connection of the fragrance release module to a computing device having communication capabilities, either by virtue of integrated electrical components, or by way of an independent communication device to which it is connected, such as, for example, a mobile phone or modem. The manner of electronic coupling can be mechanical, such as for example, being configured for reception in a USB port, or by wireless communication, for example, using a standard protocol, such as BLUETOOTH. The latter approach would permit one or more fragrance release modules to be located in various positions remote from the computing device.

According to an exemplary embodiment, software which is either stored in the fragrance module itself or which is provided to the recipient in any other acceptable format, such as, for example, physical storage media having a pre-loaded program or obtained by download from a website, is installed on the recipient's computing device. The software would advantageously constitute a RAM resident program, advantageously designed to start upon booting up of the computing device, and run in the background of other computing functions. The program would be in communication with a provider website associated with a supplier of the fragrance release modules, and would look for any communication from the party, logged onto the website, and initiating the communication to the recipient. A unique identifier, for example, the IP Address of the recipient's computer, advantageously insures that the message will only be received by the intended recipient.

Upon verification that the recipient was the intended receiver of the message sent via the website, a command is then sent to the fragrance release module selectively initiating a release of a desired amount of fragrance held therewithin. An amount of fragrance released would advantageously be selected according to, for example, the type of venue, such as indoor or outdoor, or small or large room.

Another illustrative embodiment which exemplifies a suitable alternative approach to implementing communication between the party and the recipient, would utilize the recipient's email address. In accordance with this approach, the party would log onto a provider/administrative website, and upload or compose a message advantageously made up of one or more types of media, containing for example, a written message or sentiment, images, video, a game to be played, music, etc. The party would then send the recipient an email with a link to the provider's website. Where the fragrance release module is of the type capable of selectively releasing more than one fragrance, the party could also select what fragrance was to be released in conformance with the particular message composed, such as an appropriate music passage, which might evoke a particular mood.

Once the recipient's computing device's browser is directed to the website by selection of the link in the email sent by the party, advantageously via the website, an option is advantageously made available to the recipient whether or not to open the message, and permit access by a program on the website allowing control of actuation of the fragrance release module, by suitable software, such as, for example, JavaScript. If approval is given by the recipient, the message is opened and is displayed on a display of the recipient's computing device and/or played as audio output, and fragrance is released from the fragrance release module.

According to another embodiment of the invention, the selective release of fragrance can serve as a kind of “reward” or “trophy” when the recipient achieves a preset goal. As mentioned above, the message from the presenting party to the recipient may contain a puzzle or game to be played by the recipient, in addition to, or alternative to, a written message, and would provide that, upon a successful outcome of the game or puzzle, a predetermined amount of fragrance would be released. For example, in a case where the recipient receives a crossword puzzle from the party, fragrance would be selectively released, as a type of reward, when the puzzle is solved.

The same approach can apply to other games and challenges, and even provide that the recipient obtains the fragrance release module on his or her own without a presenting party. For example, the recipient can play a game, for example, halo or fantasy football, and when a certain number of points is reached, an olfactory “trophy” or “prize” is awarded in the form of a selective fragrance release.

Game play in the above context, when the fragrance release module is given to the recipient by a party, or vice versa, can advantageously provide for a playful and flirtatious interaction between the party and the recipient in a romantic relationship, and will add more fun to personal interaction conducted in the otherwise impersonal venue of e-based communication.

In less personal situations, tying the release of a puff of fragrance to multiple games (such as, for example, video games) played on a plurality of portable devices will enhance the pleasure of the game for the participants, and perhaps make the gaming more challenging.

In accordance with the above described embodiment directed to game play, it is contemplated that the game could be played between the party and the recipient in real time over an internet connection in a well-known manner currently practiced. For example, utilizing the provider website associated with a supplier of the fragrance release modules, a selected game could be played, for example, in a chat room. Where the game was, for example, chess, fragrance could be released from the fragrance release module in communication with the recipient's computer or communication device, when a board piece of the party was captured by the recipient. Additionally, the party could also have his or her own fragrance release module, which responded in analogous fashion to provide entertainment for both the party and the recipient, for a more evenly shared experience.

While the above embodiments are directed to a fragrance module given by a party to a recipient, it is further contemplated that, instead, each of two or more parties, desirous of engaging in simultaneous game play over the internet, could purchase their own fragrance release module, each which would independently be instructed by a signal from the provider website over which the game was played by the multiple players, to release fragrance when a respective victory of one of the players was scored, or a point threshold reached.

Alternative to live game play between the part and recipient, or plural parties, the recipient could receive the game or puzzle, and whenever played later, would receive the release of a puff of fragrance upon achieving a positive outcome as a reward.

The invention will further lend itself favorably to other advantageous embodiments, for example, in a commercial setting, as well as personal. In accordance with one such example, the party presenting the fragrance release module would be a cosmetic company which would reach out to a potential consumer (i.e., recipient, in the context of the disclosed invention) via mailing of the fragrance release module which would carry a selected fragrance (or fragrances), to promote their new and existing products, carrying along therewith, a detailed description, game, puzzle or just simply a greeting. It is contemplated that eventually, as commercialization is grown, portable devices (laptop, smartphone, etc.) will have the respective recognition software of the different presenting parties (cosmetic companies) pre-loaded within them, much as in the way the software of the different printers is already pre-loaded within the current devices.

The precise configuration of the fragrance release module is not critical to practice of the invention, since several types of modules of this type have been previously described. However, it is noted that while such modules for releasing fragrance are known, a suitable fragrance release module for use in practice of the arrangement and method according to the invention will comprise, in addition to fragrance release capabilities, electronic circuitry for initiating selective operational release of fragrance in response to a received command. Such circuitry is designed to respond to a predetermined communicated signal received from the website. In this regard, the circuitry could conceivably be nothing more than a power switching mechanism.

In accordance with a method according to the invention, as noted above, the fragrance release module could be suitably configured so as to be given as a gift along with a greeting card. A sentiment would be contained in the card, according to accepted custom. The greeting card would also advantageously contain a message to the recipient describing how to receive future communications from the party gifting the card and module, for example, instructions for loading software or apps on the recipient's computing device.

A concrete example of a card and module combination is directed to a going-away card for an individual going on an extended trip. While away, the recipient could be sent an additional message or messages from the gifting party by the method according to the invention, and have a fragrance, perhaps a familiar scent which reminds the recipient of the party released, advantageously in conjunction with music or other familiar sensory-stimulating media. In this manner, the recipient will be reminded of the party, and know that he or she is being thought of, even while far away from home.

The above, and other objects, features and advantages of the present invention will become apparent from the following description read in conjunction with the accompanying drawings.

### BRIEF DESCRIPTION OF THE DRAWINGS

FIG. 1 is block diagram of a fragrance delivery system according to an embodiment of the invention; and

FIG. 2 is a perspective view of an embodiment of the invention directed to the combination of a fragrance release module, a greeting card and a gift in the form of a box of chocolates.

### DETAILED DESCRIPTION OF THE PREFERRED EMBODIMENT

Before describing the various aspects of the invention, the following considerations are outlined. In general terms, it is contemplated that the manner and details of interfacing a remote command with the fragrance release module coupled to a computing device to manifest an actuation thereof for release of at least one selected fragrance can take a number of different forms, and the invention is therefore not intended to be limited to any one precise mechanism for achieving this end. Further, it is understood that with rapid advancement of technology, the invention will continue to have relevance for practice thereof in connection with any device capable of communication and data processing. In addition, the characteristics and manner of achieving the functional attributes of the fragrance release module, disclosed herein by way of examples, are not to be construed as limiting of the scope of the invention.

Broadly stated, the invention is directed to a method, according to which, a suitably configured fragrance release module is obtained by a recipient on his or her own, or presented by a party to a willing recipient with whom the party intends to communicate in the future, and an arrangement or system for implementing the method. When presented by a presenting party, the fragrance release module can be given alone or in conjunction with a gift or a greeting card, etc. After taking possession of the fragrance release module, the recipient is instructed to establish an electronic connection with a computing device capable of receiving a transmitted communication from a remote source. Upon receipt of an electronic communication send by the party, which may advantageously comprise, in addition to a signal for initiating fragrance release by the fragrance release module, at least one form of other media, such as a written letter, video, picture, music file, or receipt of a command generated in response to the outcome of a preestablished criteria, the fragrance release module is actuated, and at least one desired fragrance contained therein is released. When coupled with one or more sensory media types directed to the natural senses (e.g., sight, hearing, etc.) comprising the communication from the party or other source in response to a predetermined event outcome, the experience of the recipient is enhanced by the multimedia effect.

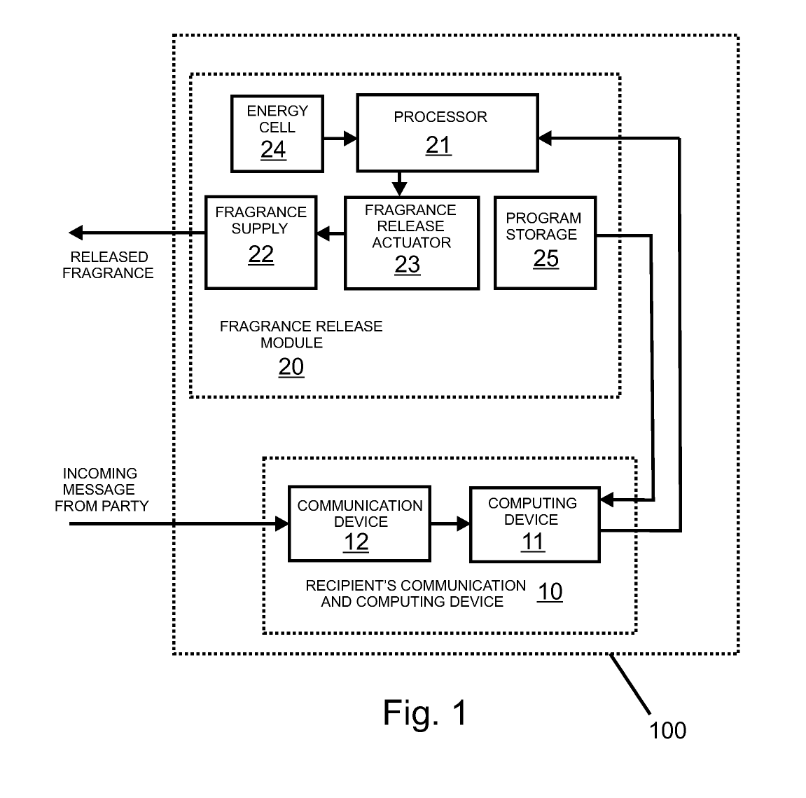

Referring now to FIG. 1, a system configured to implement reception of a message sent by the presenting party to the recipient, to process the incoming message and to effect release of fragrance in response to reception of a suitable command is depicted, generally at 100. System 100 includes a communication and computing device 10 and a fragrance release module 20. The fragrance release module 20, is electronically couplable with the communication and computing device 10.

Communication and computing device 10 comprises a processor 11 and a communication device 12. Fragrance release module 20 comprises a computing device 21, at least one fragrance supply 22 (one being shown) and at least one fragrance release actuator 23 (one being shown) which is operable to selectively dispense a measured amount of scent from the fragrance supply or supplies 22.

According to an embodiment of the method, once the fragrance release module 20 is received from the party or other wise obtained, the recipient establishes an electronic connection between the fragrance release module 20 and a computing device having communication capabilities (identified in FIG. 1 as communication and computing device 10), either by virtue of integrated electrical components, or by way of an independent communication device to which it is connected, such as for example, a mobile phone or modem. The manner of electronic coupling can be mechanical, for example, where the fragrance release module 20 is configured for reception in a USB port, or by wireless communication, for example, using a standard protocol, such as BLUETOOTH. The latter approach would optionally permit one or more fragrance release modules 20 to be located in various positions remote from the computing device 21.

In a situation in which the communication and computing device 10 does not provide power to the fragrance release module 20, either because of the manner of electronic connection or because of the nature of the communication and computing device 10, an energy cell 24 is provided for powering the computing device 21 and the fragrance release actuator 23. For example, if the manner of electronic coupling is via a USB port on a home or laptop computer, energy cell 24 would not likely be necessary, since the fragrance release module 20 could be adequately powered by the computer through the powered USB connection. However, where a smartphone functions as the communication and computing device 10, it may be necessary to have the self-contained power source provided by the option of energy cell 24, where a powered USB port was not available. The same would be true if a wireless interconnection were to be employed.

It is deemed advantageous in certain instances to have stored in the fragrance release module 20 a pre-loaded program for facilitating the reception of a communication from the presenting party. As such, a program storage 25 (memory) is optionally provided within the fragrance release module 20 on which such a program and/or other data useful in uniquely identifying a particular fragrance release module 20 is stored.

The precise configuration of the fragrance release actuator and fragrance supply is not critical to practice of the invention, since several types of such devices of this type have been previously described. However, it is noted that while such modules for releasing fragrance are per se known, a suitable fragrance release module for use in practice of the arrangement and method according to the invention will comprise, in addition to fragrance release capabilities, electronic circuitry for selectively actuating operational release of fragrance specifically in response to a received command, as described above with reference to FIG. 1 and identified as processor 21. Such circuitry of computing device 21 is designed to respond to a communicated signal received from the processor 11, generation or which is based upon a command sent by the presenting party and by set protocols recognizing the command. It is conceivable that computing device 21 could be eliminated, and replaced with a simple power switching mechanism or a switching function performed by processor 11, where power is accessible from a USB port of the processor 11, and which can be selectively terminated to prevent a constant release of fragrance.

Various examples of fragrance release devices are disclosed in previous U.S. patents and patent application publications, and as being known devices, are not disclosed herein in further detail. The patents and patent publications listed below are all incorporated herein by reference. A fragrance emitting apparatus for use with a USB port is disclosed, for example, in Patent Application Publication US 2009/0196587 A1, published Aug. 6, 2009, and which issued to Cheung on Nov. 29, 2011 as U.S. Pat. No. 8,068,725 B2, which could be suitably employed to provide the fragrance release aspects of the method, with suitable modification to allow selective actuation control. Similarly, U.S. Pat. No. 6,609,935 B2 issued to Huang on Aug. 26, 2003 also describes a fragrance emitting module equipped with a USB connector. Another example of a fragrance release module, is disclosed in U.S. Pat. No. 7,601,297 B2 issued Oct. 13, 2009 to Gygax et al. Yet a further example is disclosed in U.S. Pat. No. 7,673,820 B2 issued Mar. 9, 2010 to Ivri et al., directed to a subminiature fragrance dispenser which operates through the use of a thermoelectric transducer.

These above listed documents, the disclosures of which are incorporated herein by reference in their entireties, illustrate the wide and varied range of approaches for fragrance dispensing, and examples of structural configurations for implementing the invention.

As mentioned above, the precise manner of actuating the fragrance release module 20 remotely is not essential to the method, and can be achieved in any number of ways. Examples of these, which are by no means exhaustive of suitable approaches, are described below.

According to an exemplary embodiment, software which is either stored in the fragrance release module 20 itself or provided to the recipient in any other acceptable format, such as, for example, physical storage media or by download from a website, is installed on the recipient's computing device 11 after receiving the fragrance releasing module 20. The software would constitute a RAM resident program, advantageously designed to start upon booting up of the computing device 11, and run in the background of other computing functions. The program would be in communication with a provider website associated with a commercial supplier of the fragrance release modules 20, and would look for any communication from the presenting party, who would log onto the website, and initiate the communication to the recipient. A unique identifier, for example, the IP Address of the recipient's computer, advantageously insures that the message will only be received by the intended recipient.

Upon verification that the recipient was, in fact, the person intended to receive the message sent via the website by the party, the message is transmitted to the recipient, and when a fragrance release command is then sent to the recipient by the party, if such command satisfies preset protocols configured by the recipient, computing device 11 would instruct fragrance release module 20 to selectively initiate a release of a desired amount of fragrance supply 22 held therewithin. An amount of fragrance released would advantageously be selected according to, for example, the type of venue, such as indoor or outdoor, or small or large room by the presenting party, or by the preset protocols of the recipient.

Another illustrative embodiment which exemplifies a suitable alternative approach to implementing communication between the party and the recipient, would utilize the recipient's email address. In accordance with this approach, the party would send the recipient an email with a link to the commercial supplier's website or a website provided by an administrator of the method. Previously, the presenting party would have already logged onto the website and composed a message advantageously made up of one or more media, containing for example, a written message or sentiment, images, video, a game to be played, music, etc. Where the fragrance release module 20 is of a type capable of selectively releasing more than one fragrance, the party could also select what fragrance were to be released in conformance with the particular message composed. For example, an appropriate music passage in combination with a particular fragrance might be selected to evoke a particular mood.

Once the browser of the recipient's communication and computing device 10 is directed to the website by selection of the link in the email sent by the party, advantageously via the website, an option is advantageously made available to the recipient whether or not to open the message, and permit access by a program on the website allowing control of actuation of the fragrance release module, by suitable software, such as, for example, JavaScript. If approval is given by the recipient, the message is opened and is displayed on a display of the recipient's computing device and/or played as audio output, and fragrance is released from the fragrance release module.

Another embodiment of a method according to the invention achieves a more direct communication between the presenting party and the recipient via a website which provides a switchboard function by ascertaining the IP address of the respective parties based upon a unique identifier provided by the party and the recipient when initially logged onto the website. This approach would allow for a more real time exchange between the party and the recipient.

In accordance with this embodiment, the manufacturer would advantageously provide each fragrance release module 20 with a serial number serving as the unique identifier. The presenting party would log onto the website associated with, or administered for, the manufacturer of the fragrance release module 20 and download a program. Such program or mobile app (for example, when a smartphone is used as the communication device of one or both of the party and the recipient) would serve as an communication interface for transmission and reception of text and/or other types of data transfer, including, for example, images, music, etc. The program or app would advantageously be configurable by the party so as to allow the program to be customized to suit individual preferences, such as how the fragrance release command is initiated (e.g., by dedicated keystroke, password, etc), the duration of the fragrance release, whether images are to be sent, and any other criteria involving what a message would constitute what is transmitted over the subsequently established connection between the party and the recipient, as will be described below. The party would then create an account using the manufacturer-provided serial number.

When the fragrance release module 20 is received by the recipient, program storage 25 contained therein (see FIG. 1) would advantageously have stored thereon a program or app corresponding to the program or app previously downloaded by the party onto his or her own communication and computing device, along with the serial number. Such program would advantageously be auto-installed (or auto-prompted for installation by the recipient) when the module is electronically connected to the recipient's computing device 11 via, for example, a USB connection. Once loaded onto computing device 11, the recipient could also customize the interface, and select for example, a level of security as to when fragrance release will be accepted, as well as other preferences. The serial number would serve to establish the party and the recipient of a particular fragrance release module as the two unique parties intended for mutual communication when both are logged onto the website using the program or app.

When logged on at the same time, the website, acting as a switchboard, would connect the party and the recipient and allow communication therebetween and transmission, when desired, of a fragrance release command from the party to the recipient, alone or in combination with an accompanying type or types of media, using the interface provided by the downloaded programs.

It is understood that when the program is provided in the form of a mobile app, and the respective communication and computing devices of the party and the recipient are smartphones, the connection between devices can be established simply by a phone connection and the communication between devices using the interface provided by the respectively loaded apps can also conceivably be conducted over the existing cellular network in lieu of the Internet.

It is recognized that email alone could be used to initiate actuation of the fragrance release module by having a program attachment, which when opened by the recipient would be installed so as to play the message and control the release of fragrance, and such approach is considered to be included within the scope of the invention. However, a website-based implementation of the inventive method is deemed preferable, insofar as there is less threat of virus infiltration and filtering by spam blockers on the recipient's computing device 11.

In accordance with an embodiment of the invention finding particular commercial advantage, the fragrance release module 20 and optionally an accompanying greeting card or gift originating from a commercial manufacturing source, is purchased by the presenting party for later presentation to the recipient. Advantageously, the fragrance release module 20 could be suitably configured so as to be given as a gift along with a greeting card. A sentiment would be contained in the card, according to accepted custom. The greeting card would also advantageously contain a message to the recipient describing how to receive future communications from the party gifting the card and module, for example, instructions for loading software or apps on the recipient's computing device 11.

A concrete example of a card and fragrance release module combination is directed to a going-away card for an individual (recipient) going on an extended trip. While away, the recipient could be sent an additional message or messages from the gifting party (presenting party) by the method according to the invention, and have a fragrance, perhaps a familiar scent which reminds the recipient of the party, released, advantageously in conjunction with music or other familiar sensory-stimulating media. In this manner, the recipient will be reminded of the party, and know that he or she is being thought of, even while far away from home.

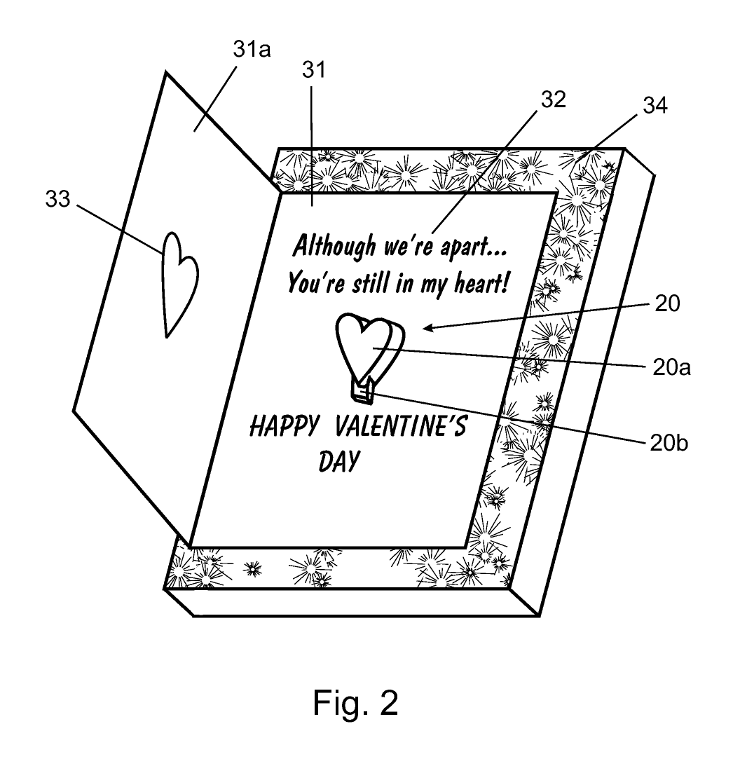

Turning now to FIG. 2, an embodiment of the invention developed along the above lines is depicted, in which a suitably configured fragrance release module 20 is given by the presenting party in conjunction with a greeting card 31 and/or a gift 34. Greeting card 31, which in the depicted example is a Valentine's Day card, includes an appropriate preprinted sentiment 32 and includes a fragrance release module 20 removably fastened to the inside of the card 31 having a decoratively shaped main body 20, designed in the shape of a heart. The greeting card 31 is conveniently attached to a gift 34, for example, a box of chocolates.

Within main body 20, is housed the various elements 22, 23, 21, and where required, also energy cell 24 (e.g., for use with a smartphone lacking a powered USB port), shown within the fragrance release module 20 depicted in FIG. 1. The fragrance release module 20 in FIG. 2 also includes a particular type USB connector 20b adapted to fit either a computer or smartphone, as commercially determined by marketing preference. A cutout 33 in the card cover 31a of a shape corresponding generally to the fragrance release module 20, which in the depicted example is heart-shaped, allows the fragrance release module 20 to protrude from the card 31 when cover 31a is closed.

This embodiment advantageously lends itself to use of the method according to the invention, described above, which utilizes a serial number or other unique identifier to create a connection between the party and the recipient using a website as a switchboard and specialized software to provide a communication interface on the display of the computing device 11. As such, program storage 25 in fragrance release module 20 advantageously has stored thereon a program which either auto-installs or auto-prompts the recipient to install the program on the computing device 11 when the USB connector 20b of fragrance release module 20 is plugged into the computing device 11.

It is noted that, while practice of the invention lends itself quite well to application in the context of personal human interaction, in which the presenting party may have romantic interest in the recipient, the invention will also find utility in a less intimate setting, such as when used in various social venues, such as restaurants, theaters, etc., in which the party is the business establishment, and the recipient is a patron thereof. For example, in a setting in which music is playing over a sound system of the venue, one or more fragrances could be released at a timing coupled to particular passages, to deepen the listening experience and overall ambience of the gathering establishment. It is also contemplated that several recipients could each be given a fragrance release module by the establishment for later actuation either separately or in unison.

It should be further noted that while the previously described embodiments conveniently utilize the Internet and cellular phone connections and cellular networks between the party and the recipient to transmit the command to selectively release fragrance, any suitable form of data transmission is deemed included within the contemplated scope of the invention. For example, in the above described embodiment directed to use within a public venue, such as a restaurant, club, theater, etc., the transmission can be effected over a wireless network provided by the party (for example, the business establishment) for transmission to a WiFi-enabled device using a suitable device-recognition protocol which identifies the device of the particular patron, or via BLUETOOTH, etc., and be conducted entirely over a LAN (local area network) or any other network, without need of the Internet.

According to yet another example of the invention, the selective release of fragrance can serve as a kind of “reward” or “trophy” when the recipient achieves a preset goal. As mentioned above, the message from the party to the recipient may contain a puzzle or game to be played by the recipient, in addition to, or alternative to, a written message, and would provide that, upon a successful outcome of the game or puzzle, a predetermined amount of fragrance would be released. For example, in a case where the recipient receives a crossword puzzle from the party, fragrance would be selectively released, as a type of reward, when the puzzle is solved.

The same approach can apply to other games and challenges. For example, the recipient can play a game, for example, halo or fantasy football, and when a certain number of points is reached, an olfactory “trophy” or “prize” is awarded in the form of a selective fragrance release.

Game play in the above context can advantageously provide for a playful and flirtatious interaction between the party and the recipient in a romantic relationship, and will add more fun to personal interaction conducted in the otherwise impersonal venue of e-based communication. In less personal situations, tying the release of a puff of fragrance to multiple games (such as, for example, video games) played on a plurality of portable devices will enhance the pleasure of the game for the participants, and perhaps make the gaming more challenging.

In accordance with the above described embodiment directed to game play, it is contemplated that the game could be played between the party and the recipient in real time over an internet connection in a well-known manner currently practiced. For example, utilizing the provider website associated with a supplier of the fragrance release modules, a selected game could be played, for example, in a chat room. Where the game was, for example, chess, fragrance could be released from the fragrance release module in communication with the recipient's computer or communication device, when a board piece of the party was captured by the recipient. Additionally, the party could also have his or her own fragrance release module, which responded in analogous fashion to provide entertainment for both the party and the recipient, for a more evenly shared experience.

While the above embodiments are directed to a fragrance module given by a party to a recipient, it is further contemplated that, instead, each of two or more parties, desirous of engaging in simultaneous game play over the internet, could purchase their own fragrance module, each which would independently be instructed by a signal from the provider website over which the game was played by the multiple players, to release fragrance when a respective victory of one of the players was scored, or a point threshold reached.

As mentioned above, alternative to live game play between the part and recipient, or plural parties, the recipient could receive the game or puzzle, and whenever played later, would receive the release of a puff of fragrance upon achieving a positive outcome as a reward.

In accordance with a variation of the above-described embodiments, the fragrance release module will carry two fragrances of differing olfactory appeal, for example, in an extreme case, a very good one and a very bad one. When the recipient is playing a game (chess, halo, etc.) or when the recipient is trying to solve a puzzle, if he or she loses (or does not reach the predetermined goal), then the device will automatically release the bad smelling fragrance, causing embarrassment, as opposed to the rewarding release of the good fragrance in the event of a win. The recipient is warned from the beginning about this possible negative outcome as the result of failure, so that he or she will be compelled to do well, thus making the experience more interesting and challenging.

The invention will further lend itself favorably to other advantageous embodiments, for example, in a commercial setting, as well as personal. In accordance with one such example, the party presenting the fragrance release module would be a cosmetic company which would reach out to a potential consumer (i.e., recipient, in the context of the disclosed invention) via mailing of the fragrance release module which would carry a selected fragrance (or fragrances), to promote their new and existing products, carrying along therewith, a detailed description, game, puzzle or just simply a greeting. It is contemplated that eventually, as commercialization is grown, portable devices (laptop, smartphone, etc.) will have the respective recognition software of the different presenting parties (cosmetic companies) pre-loaded within them, much as in the way the software of the different printers is already pre-loaded within the current devices, so that subsequent download is not necessary, as described above herein.

It is noted that, if economically feasible, the invention can be implemented by providing a fragrance release device as an integral part of a communication device, instead of in the form of a module, such that the party presents the recipient with a self contained device capable of receiving the later communication and command by suitable transmission means and to selectively release fragrance.

Having described preferred embodiments of the invention, it is to be understood that the invention is not limited to those precise embodiments, and that various changes and modifications may be effected therein by one skilled in the art without departing from the scope or spirit of the invention.

What is claimed is:

1. A method of personalizing electronic communication, comprising:
presenting a fragrance release module configured to selectively release a measured amount of fragrance responsive to an initiated signal by a party to a willing recipient;
establishing a communication connection between the party and the recipient;
sending a message from the party to the recipient; and
selectively releasing the measured amount of fragrance in response to a message criteria.

2. A method according to claim 1, wherein said communication connection is established over a network.

3. A method according to claim 1, wherein said message includes one or more types of sensory media directed to various natural senses.

4. A method according to claim 1, wherein said party and said recipient are both natural persons.

5. A method according to claim 1, wherein said party is a business entity and said recipient is a customer or potential customer of said party.

6. A method according to claim 1, wherein the measured amount of fragrance can be adjusted by at least one of the party or the recipient.

7. A method according to claim 1, wherein:
the message from the party to the recipient includes a puzzle or game to be played by the recipient; and
said selectively releasing the measured amount of fragrance is effected in response to progress or outcome of the puzzle or game.

8. A method according to claim 1, wherein said message criteria includes a command sent in the message by the party to the recipient which initiates the selectively releasing the measured amount of fragrance.

9. A fragrance release module, comprising:
a computing device electronically connectable to a computer or smartphone;
at least one fragrance supply; and
at least one fragrance release actuator which is operable to selectively dispense a measured amount of scent from the at least one fragrance supply; and

10. A fragrance release module according to claim 9, further comprising an energy cell for powering the computing device and the fragrance release actuator.

11. A fragrance release module according to claim 9, further comprising a program storage memory on which is stored a pre-loaded program.

12. A fragrance release module according to claim 9, further comprising an associated serial number which serves as a unique identifier.

13. A fragrance release module according to claim 9, further comprising a USB connector for electronically connecting the computing device to the computer or smartphone.

14. A fragrance release module according to claim 9, in combination with at least one of a greeting card or a gift.

15. A method of enhancing simultaneous internet game play for two or more players, comprising:
providing to each of the two or more players, a fragrance release module configured to selectively release a measured amount of fragrance responsive to a signal initiated from a provider website on which a game is played by the two or more players; and
sending the signal to a one of the two or more players based upon a predetermined condition being met during the game play.
